(19) United States
(12) Patent Application Publication
(10) Pub. No.: US 2023/0024055 A1
(43) Pub. Date: Jan. 26, 2023

(54) METHOD AND APPARATUS FOR TRANSMITTING DATA AND COMMUNICATION SYSTEM

(71) Applicant: FUJITSU LIMITED, Kawasaki-shi (JP)

(72) Inventors: Yang LU, Beijing (CN); Guorong LI, Beijing (CN)

(73) Assignee: FUJITSU LIMITED, Kawasaki-shi (JP)

(21) Appl. No.: 17/957,272

(22) Filed: Sep. 30, 2022

Related U.S. Application Data
(63) Continuation of application No. PCT/CN2020/084307, filed on Apr. 10, 2020.

(51) Int. Cl. H04W 72/12; H04W 72/14

(52) U.S. Cl. CPC H04W 72/1268; H04W 72/14; H04W 72/1242; H04W 72/1289; H04W 80/02

(57) ABSTRACT

A method and apparatus for transmitting data and a communication system. The apparatus for transmitting data includes a first processing unit, which is configured to transmit a second physical uplink shared channel (PUSCH) by the terminal equipment in a case where a first physical uplink shared channel (PUSCH) and the second physical uplink shared channel (PUSCH) have identical physical layer priorities and transmission of the first physical uplink shared channel (PUSCH) and transmission of the second physical uplink shared channel (PUSCH) at least partially overlap in the time domain.

### CROSS-REFERENCE TO RELATED APPLICATION

This application is a continuation application of International Application PCT/CN2020/084307 filed on Apr. 10, 2020, and designated the U.S., the entire contents of which are incorporated herein by reference.

### TECHNICAL FIELD

This disclosure relates to the field of wireless communication technologies.

### BACKGROUND

In a communication system, resource preemption between terminal devices or resource preemption between different services in terminal devices sometimes occurs.

For example, when the time-frequency domain resources of the downlink air interface of the two terminals collide, the network device preferentially ensures the transmission of the service with the higher priority in the two terminal devices, and passes special downlink control information (for example, DCI2-1) to notify the terminal equipment that the resource is preempted. This resource preemption mechanism enables data of high-priority services to be transmitted with high priority, thereby improving the real-time performance and reliability of high-priority services. For another example, resource preemption within the terminal equipment may also be performed based on the priority of the service.

For uplink transmission conflicts within the terminal, the media access control (MAC) layer and the physical (PHY) layer determine the preemption priority independently. For example, the MAC layer determines the preemption priority according to the logical channel priority, and the PHY layer determines the preemption priority according to the physical layer priority.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

As a MAC layer and a PHY layer independently determine preemption priorities, transmission that may be determined to be of a higher priority at the MAC layer may possibly be determined to be of a lower priority at the PHY layer, and data of an uplink grant that the MAC layer deems as being of a higher priority may possibly be dropped at the PHY layer. In this way, data automatically transmitted by a terminal equipment on a configured grant (CG) will be lost due to being unable to be transmitted.

It was found by the inventors of this disclosure that in a case where physical layer priorities of two physical uplink shared channels (PUSCHs) are identical and transmission of the two PUSCHs at least partially overlaps in the time domain, how a terminal equipment transmits data of the two PUSCHs is not specified in the related art.

Embodiments of this disclosure provide a method and apparatus for transmitting data and a communication system, in which in a case where a first physical uplink shared channel (PUSCH) and a second physical uplink shared channel (PUSCH) have identical physical layer priorities and transmission of the first physical uplink shared channel (PUSCH) and transmission of the second physical uplink shared channel (PUSCH) at least partially overlap in the time domain, the terminal equipment transmits or does not transmit the second physical uplink shared channel (PUSCH). Hence, reliabilities of communication services may be ensured.

According to a first aspect of the embodiments of this disclosure, there is provided a method for transmitting data, applicable to a terminal equipment, the method including:

transmitting a second physical uplink shared channel (PUSCH) by the terminal equipment in a case where a first physical uplink shared channel (PUSCH) and the second physical uplink shared channel (PUSCH) have identical physical layer priorities and transmission of the first physical uplink shared channel (PUSCH) and transmission of the second physical uplink shared channel (PUSCH) at least partially overlap in the time domain.

According to a second aspect of the embodiments of this disclosure, there is provided a method for transmitting data, applicable to a terminal equipment, the method including:

in a case where a first physical uplink shared channel (PUSCH) and a second physical uplink shared channel (PUSCH) have identical physical layer priorities, and transmission of the first physical uplink shared channel (PUSCH) and the transmission of the second physical uplink shared channel (PUSCH) at least partially overlap in the time domain, not transmitting the second physical uplink shared channel (PUSCH) by the terminal equipment.

According to a third aspect of the embodiments of this disclosure, there is provided a method for transmitting data, applicable to a terminal equipment, the method including:

in a case where a first physical uplink shared channel (PUSCH) and a second physical uplink shared channel (PUSCH) have identical physical layer priorities and transmission of the first physical uplink shared channel (PUSCH) and transmission of the second physical uplink shared channel (PUSCH) at least partially overlap in the time domain, determining to transmit or not to transmit the second physical uplink shared channel (PUSCH) by the terminal equipment according to types of the first physical uplink shared channel (PUSCH) and the second physical uplink shared channel (PUSCH).

According to a fourth aspect of the embodiments of this disclosure, there is provided an apparatus for transmitting data, applicable to a terminal equipment, and carrying out the method for transmitting data as described in the embodiment of the first or the second or the third aspect of this disclosure.

According to a fifth aspect of the embodiments of this disclosure, there is provided a terminal equipment, including the apparatus for transmitting data as described in the embodiment of the fourth aspect of this disclosure.

According to a sixth aspect of the embodiments of this disclosure, there is provided a communication system, including the terminal equipment as described in the embodiment of the fifth aspect of this disclosure and a network device.

According to a seventh aspect of the embodiments of this disclosure, there is provided a computer readable program code, which, when executed in an apparatus for transmitting data or a terminal equipment, will cause the apparatus for transmitting data or the terminal equipment to carry out the method for transmitting data as described in the embodiment of the first or the second or the third aspect of this disclosure.

According to an eighth aspect of the embodiments of this disclosure, there is provided a computer readable medium, including a computer readable program code, which will cause an apparatus for transmitting data or a terminal equipment to carry out the method for transmitting data as described in the embodiment of the first or the second or the third aspect of this disclosure.

An advantage of the embodiments of this disclosure exists in that in a case where a first PUSCH and a second PUSCH have identical physical layer priorities and transmission of the first PUSCH and transmission of the second PUSCH at least partially overlap in the time domain, the terminal equipment transmits or does not transmit the second PUSCH. Hence, processing of whether to transmit PUSCHs by the media access control layer and the physical layer of the terminal equipment may be unified, which may avoid loss of data automatically transmitted by the terminal equipment on the configured grant (CG), thereby ensuring reliabilities of communication services.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of an embodiment of this disclosure;

FIG. 2 is a schematic diagram of dropping a PUSCH of a higher priority by a physical layer;

FIG. 3 is another schematic diagram of dropping a PUSCH of a higher priority by a physical layer;

FIG. 4 is a schematic diagram of the method for transmitting data of the first aspect of the embodiments of this disclosure;

FIG. 5 is a schematic diagram of operations of an MAC layer and a physical layer of the first aspect of the embodiments of this disclosure;

FIG. 6 is another schematic diagram of the operations of the MAC layer and the physical layer of the first aspect of the embodiments of this disclosure;

FIG. 7 is a schematic diagram of the method for transmitting data of Embodiment 1 of the second aspect of the embodiments of this disclosure;

FIG. 8 is a schematic diagram of operations of an MAC layer and a physical layer of Embodiment 1 of the second aspect of the embodiments of this disclosure;

FIG. 9 is another schematic diagram of the operations of the MAC layer and the physical layer of Embodiment 1 of the second aspect of the embodiments of this disclosure;

FIG. 10 is a schematic diagram of the method for transmitting data of Embodiment 2 of the second aspect of the embodiments of this disclosure;

FIG. 11 is a schematic diagram of operations of an MAC layer and a physical layer of Embodiment 2 of the second aspect of the embodiments of this disclosure;

FIG. 12 is a schematic diagram of operations of an MAC layer and a physical layer of Embodiment 2 of the second aspect of the embodiments of this disclosure;

FIG. 13 is a schematic diagram of the method for transmitting data of the third aspect of the embodiments of this disclosure;

FIG. 14 is a schematic diagram of the apparatus for transmitting data of the fourth aspect of the embodiments of this disclosure; and

FIG. 15 is a block diagram of a systematic structure of the terminal equipment of the fifth aspect of the embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims. Various implementations of this disclosure shall be described below with reference to the accompanying drawings. These implementations are illustrative only, and are not intended to limit this disclosure.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which may be expressed as a serving cell, and may be an MACro cell or a pico cell, depending on a context of the term.

In the embodiments of this disclosure, the term “user equipment (UE)” or “terminal equipment (TE)” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The user equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and an machine to machine (M2M) terminal, etc.

Scenarios of the embodiments of this disclosure shall be described below by way of examples; however, this disclosure is not limited thereto.

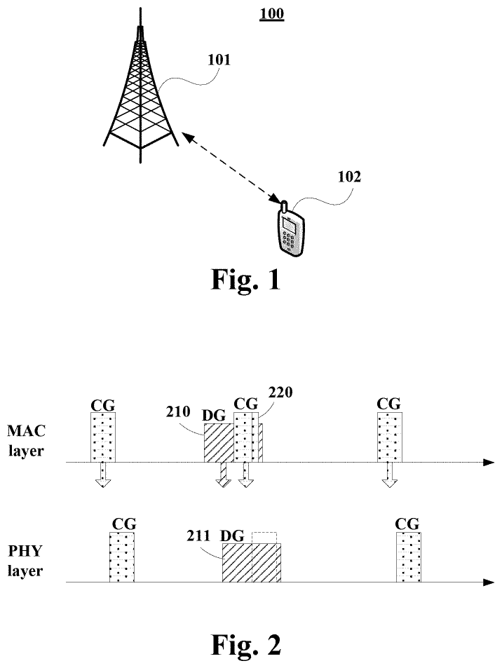

FIG. 1 is a schematic diagram of a communication system of an embodiment of this disclosure, in which a case where a terminal equipment and a network device are taken as examples is schematically shown. As shown in FIG. 1, the communication system 100 may include a network device 101 and a terminal equipment 102. For the sake of simplicity, an example having only one terminal equipment is schematically given in FIG. 1.

In the embodiment of this disclosure, existing traffics or traffics that may be implemented in the future may be performed between the network device 101 and the terminal equipment 102. For example, such traffics may include but not limited to enhanced mobile broadband (eMBB), massive machine type communication (MTC), and ultra-reliable and low-latency communication (URLLC), etc.

The terminal equipment 102 may transmit data to the network device 101, for example, in a grant-free transmission mode. The network device 101 may receive data transmitted by one or more terminal equipments 102, and feed back information (such as acknowledgement ACK/non-acknowledgement NACK) to the terminal equipment 102, and the terminal equipment 102 may acknowledge terminating a transmission process according to the feedback information, or may further perform new data transmission, or may perform data retransmission.

Following description shall be given by taking that a network device in a communication system is a receiver end or a transmitter end and a terminal equipment is a transmitter end or a receiver end as an example. However, this disclosure is not limited thereto, and the transmitter end and/or the receiver end may also be other devices. For example, this disclosure is applicable to not only uplink grant-free transmission between a network device and a terminal equipment, but also sidelink grant-free transmission between two terminal equipments.

In the following embodiments of this disclosure, that a CG is not transmitted means that MAC PDU data generated according to configuration of the CG is not transmitted by a physical layer, wherein the MAC PDU may also be referred to as an untransmitted MAC PDU.

Application scenarios of this disclosure shall be described below.

Transmission conflicts within a terminal equipment may occur between resource grants of different physical uplink shared channels (PUSCHs), such as occurring between PUSCHs of two semi-static configured grants (CGs), or occurring between a configured grant and a dynamically scheduled PUSCH. For conflicts generated between PUSCH resource grants and different scheduling request (SR) transmissions or acknowledgement (ACK)/negative acknowledgement (NACK) indications for downlink PUSCHs, the terminal equipment preferentially guarantees transmission of a PUSCH, SR or physical uplink control channel (PUCCH) ACK/NACK of services of higher priorities. A media access control (MAC) layer of the terminal equipment ensures the preferential transmission of the services of higher priorities by determining a preferentially transmitted PUSCH grant or SR according to a logical channel priority. When a PUSCH transport block multiplexes multiple logical channel data, the priority of the PUSCH grant is determined by a logical channel of a highest priority multiplexed in the transport block, and a priority of an SR transmission is determined by a logical channel priority to which the SR corresponds. In a case of conflicts between two or more resources, the PUSCH grant of the highest priority or the SR of the highest priority is determined as being of a high priority and is preferentially transmitted by the MAC layer, and other grants or SR transmissions are determined as being of low priorities and are preempted.

For an uplink transmission conflict inside the terminal, the MAC layer and the PHY layer independently determine transmission priorities, the MAC layer determines the transmission priority according to the logical channel priority, and the PHY layer determines the transmission priority according to the physical layer priority. The physical layer priority (high or low) of the PUSCH of the configured grant (CG) is indicated to the terminal equipment by the network device via a radio resource control (RRC) message, and the physical layer priority (high or low) of the dynamically scheduled PUSCH is indicated by the network device to the terminal equipment via the PDCCH signaling that schedules the PUSCH.

The network device configures a logical channel priority (1-16), a list of allowed CG configurations and a physical layer priority (high or low) for each logical channel, and uplink PUSCH permission of each CG configuration may multiplex multiple logical channel data allowed to be multiplexed. A dynamic scheduling uplink PUSCH grant may multiplex data of multiple logical channels with the same physical layer priority as the PUSCH grant. If a PUSCH grant may multiplex multiple logical channel data, at the MAC layer of the terminal equipment, the priority of the uplink grant is determined by the logical channel with the highest priority that may be multiplexed, and a priority of an SR transmission is determined by a corresponding logical channel priority. In a case of conflicts between two or more resources, the PUSCH grant of the highest priority or the SR of the highest priority is transmitted by the MAC layer first, and other grants or SRs will be preempted, and uplink transmission will not be triggered.

At the MAC layer, if the uplink grant is an uplink grant of a high priority (preferentially transmitted), the terminal equipment obtains the MAC PDU from a multiplexing and encapsulation entity and makes an HARQ process associated with the grant trigger data transmission. If it is a grant of low priority (i.e. preempted), the terminal equipment does not obtain the MAC PDU and trigger transmission of data. For a grant temporarily determined as being of high priority, the terminal equipment may possibly have obtained the MAC PDU and triggered physical layer transmission of data, but it may possibly be re-determined as a grant of low priority when logical channel data of high priorities arrive, as a priority of a next uplink grant or SR transmission may be higher than the priority of the uplink grant having generated data. A grant of a higher priority may also generate data and trigger physical layer transmission. At the PHY layer of the terminal equipment, a priority of uplink transmission is determined by the physical layer priority of the PUSCH. If the MAC layer instructs the physical layer to transmit two uplink data overlapping in resources, the physical layer preferentially transmits the uplink data with a higher physical layer priority.

However, if two PUSCHs overlap and the physical layer priorities thereof are identical, data with high priorities at the MAC layer may be dropped by the physical layer. Hence, the configured grant (CG) data automatically transmitted by the terminal equipment will be lost as it is unable to be transmitted. If the CG data determined by the MAC layer as being of high priorities are dropped by the physical layer, the CG data will not be automatically retransmitted by the MAC layer, as the MAC may only able to actively retransmit data determined by the MAC layer as being of low priorities, while the network device will also not schedule retransmission of the CG data, as the CG data are not actually transmitted to the network device.

FIG. 2 is a schematic diagram of dropping a PUSCH of a higher priority by the physical layer. As shown in FIG. 2, the transmission of the PUSCH of the CG and the transmission of the PUSCH of a dynamic scheduling grant (DG) at least partially overlap in the time domain, and the PUSCH of the CG and the PUSCH of the DG have identical physical layer priorities. The MAC layer first generates a dynamic scheduling protocol data unit (PDU) 210, and then generates a PDU 220 of the CG of a higher priority, but the physical layer preferentially transmits the PUSCH 211 of the dynamic scheduling grant, and the PUSCH 211 of the DG corresponds to the PDU 210 of the DG.

FIG. 3 is another schematic diagram of dropping a PUSCH of a higher priority by the physical layer. As shown in FIG. 3, transmission of a PUSCH of CG1 and transmission of a PUSCH of a DG2 at least partially overlap in the time domain, and the PUSCH of CG1 and the PUSCH of DG2 have identical physical layer priorities. The MAC layer first generates a protocol data unit (PDU) 310 of CG1, and then generates a PDU 320 of CG2 of a higher priority, but the physical layer preferentially transmits the PUSCH 311 of CG1, wherein PUSCH 311 of CG1 corresponds to PDU 310 of CG1.

### First Aspect of the Embodiments

The first aspect of the embodiments provides a method for transmitting data, applicable to a terminal equipment, such as the terminal equipment 102.

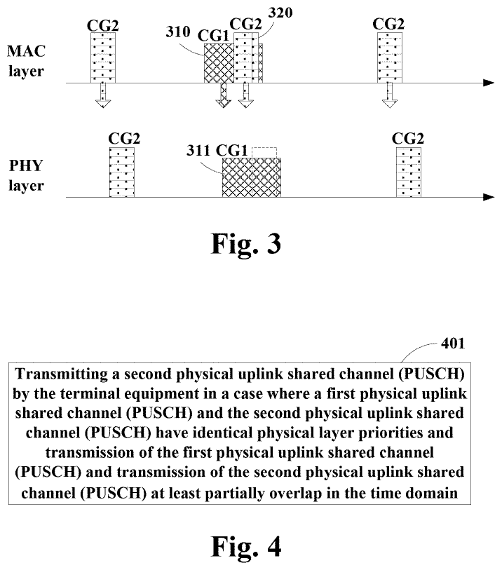

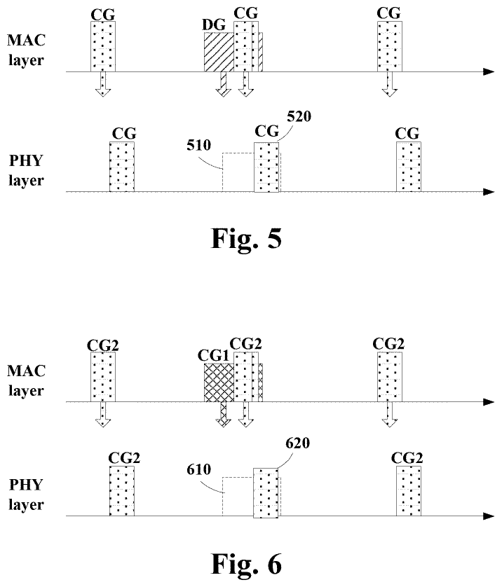

FIG. 4 is a schematic diagram of the method for transmitting data of the first aspect of the embodiments of this disclosure. As shown in FIG. 4, the method for transmitting data may include:

operation 401: transmitting a second physical uplink shared channel (PUSCH) by the terminal equipment in a case where a first physical uplink shared channel (PUSCH) and the second physical uplink shared channel (PUSCH) have identical physical layer priorities and transmission of the first physical uplink shared channel (PUSCH) and transmission of the second physical uplink shared channel (PUSCH) at least partially overlap in the time domain. According to the first aspect of the embodiments, when the first PUSCH and the second PUSCH have identical physical layer priorities and the transmission of the first PUSCH and the transmission of the second PUSCH at least partially overlap in the time domain, the terminal equipment transmits the second PUSCH, thereby ensuring reliabilities of communication services.

In the first aspect of the embodiments, the moment when the physical layer of the terminal equipment 102 receives the data of the second physical uplink shared channel (PUSCH) from the media access control (MAC) layer is later than the moment when the data of first physical uplink shared channel (PUSCH) is received, that is, the second PUSCH has a priority higher than that of the first PUSCH. Hence, the physical layer is able to transmit the data of the second PUSCH having a higher priority.

In at least one embodiment, the first physical uplink shared channel (PUSCH) is a physical uplink shared channel (PUSCH) scheduled by first downlink control information (DCI), and the second physical uplink shared channel (PUSCH) is a physical uplink shared channel (PUSCH) of a configured grant (CG).

In at least another embodiment, the first physical uplink shared channel (PUSCH) is a physical uplink shared channel (PUSCH) of a configured grant (CG), and the second physical uplink shared channel (PUSCH) is a physical uplink shared channel (PUSCH) of a configured grant (CG).

Operation 401 shall be specifically described below.

For each PUSCH grant, the MAC layer of the terminal equipment 102 determines a priority according to a logical channel of a highest priority that may be multiplexed by the grant, and then determines whether it is an uplink grant of a high priority or an uplink grant of a low priority according to the priority of the grant.

For a configured grant (CG), if no PUSCH of other CGs of higher priorities overlaps the PUSCH of this CG, no PUSCH of a configured grant of a higher priority or an identical priority overlaps the PUSCH of this CG and no PUSCH of an SR of a higher priority overlaps the PUSCH of this CG, the CG grant is an uplink grant of a high priority, and other overlapping uplink grants are uplink grants of low priorities.

For a dynamic scheduling grant (DG), i.e. uplink scheduling with a physical downlink control channel (PDCCH) addressed to a configured scheduling radio network temporary identifier (CS-RNTI) and NDI of 1, or dynamic scheduling addressed to a cell radio network temporary identifier (C-RNTI), if no PUSCH of a CG of a higher priority overlaps a PUSCH of the dynamic scheduling grant and no PUCCH resource of SR transmission of a higher priority overlaps a PUSCH resource of the dynamic scheduling grant, the dynamic scheduling grant is a grant of high priority, and other overlapping uplink grants are determined as grants of low priorities.

At the MAC layer, for a grant that is temporarily determined as being of a high priority, the terminal equipment 102 may have acquired PUSCH data and triggered PHY layer transmission of the data, but the grant may be re-determined as a grant of low priority when logical channel data of a higher priority arrive, as a priority of a next uplink grant or SR may have a priority higher than the priority of the uplink grant having generated data. Therefore, the grant of a higher priority may also obtain PUSCH data and transmit the data to the PHY layer. At the PHY layer of the terminal, the uplink transmission priority is determined by the physical layer priority of the PUSCH, and the physical layer preferentially transmits uplink data of higher physical layer priorities. However, if two PUSCHs overlap and the physical layer priorities are identical, data of high priorities at the MAC layer may be dropped by the physical layer.

Therefore, in the first aspect of the embodiments, the first physical uplink shared channel (PUSCH) and the second physical uplink shared channel (PUSCH) have identical physical layer priorities, and in a case where the transmission of the first physical uplink shared channel (PUSCH) and the transmission of the second physical uplink shared channel (PUSCH) at least partially overlap in the time domain, if a moment when the physical layer of the terminal equipment 102 receives the data of the second physical uplink shared channel (PUSCH) from the media access control (MAC) layer is later than the moment when it receives the data of the first physical uplink shared channel (PUSCH), the terminal equipment 102 may transmit the second physical uplink shared channel (PUSCH), and does not transmit the data of the first PUSCH, thereby avoiding a problem that the data of high priorities at the MAC layer (i.e. the data of the second PUSCH) are dropped by the PHY layer.

FIG. 5 is a schematic diagram of operations of the MAC layer and the physical layer of the first aspect of the embodiments of this disclosure. As shown in FIG. 5, a first PUSCH 510 is a PUSCH scheduled by first downlink control information (i.e. the dynamic scheduling grant (DG)), a second PUSCH 520 is a PUSCH of a configured grant (CG), a moment when data of the second PUSCH 520 arrive the physical layer is later than a moment when data of the first PUSCH 510 arrive the physical layer, and the physical layer of the terminal equipment 102 transmits the second PUSCH 520.

FIG. 6 is another schematic diagram of the operations of the MAC layer and the physical layer of the first aspect of the embodiments of this disclosure. As shown in FIG. 6, a first PUSCH 610 is a PUSCH of CG1, a second PUSCH 620 is a PUSCH of CG2, a moment when data of the second PUSCH 620 arrive the physical layer is later than a moment when data of the first PUSCH 610 arrive the physical layer, and the physical layer of the terminal equipment 102 transmits the second PUSCH 620.

### Second Aspect of the Embodiments

The second aspect of the embodiments of this disclosure provides a method for transmitting data, applicable to a terminal equipment, such as the terminal equipment 102.

In the method for transmitting data in the second aspect of the embodiments of this disclosure, a first physical uplink shared channel (PUSCH) and a second physical uplink shared channel (PUSCH) have identical physical layer priorities, and in a case where transmission of the first physical uplink shared channel (PUSCH) and transmission of the second physical uplink shared channel (PUSCH) at least partially overlap in the time domain, the terminal equipment 102 does not transmit the second physical uplink shared channel (PUSCH).

In the second aspect of the embodiments of this disclosure, the method for transmitting data may further include: transmitting the first physical uplink shared channel (PUSCH) by the terminal equipment 102.

### Embodiment 1

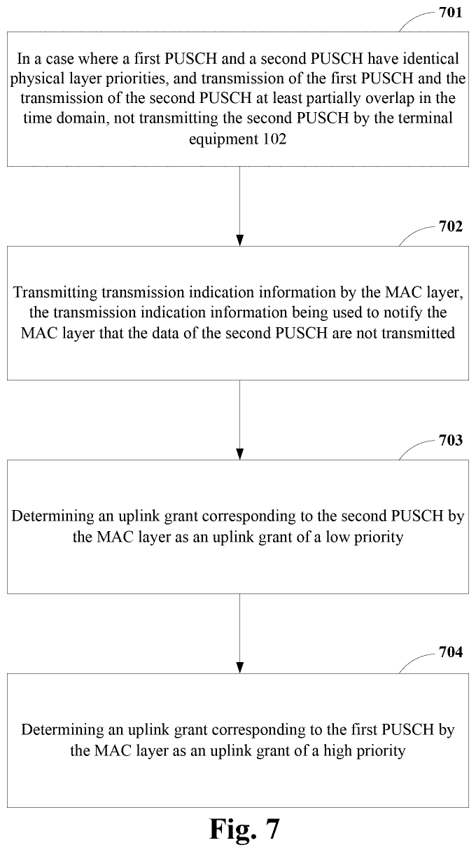

FIG. 7 is a schematic diagram of the method for transmitting data of Embodiment 1 of the second aspect of the embodiments of this disclosure. As shown in FIG. 7, the method includes:

operation 701: in a case where a first physical uplink shared channel (PUSCH) and a second physical uplink shared channel (PUSCH) have identical physical layer priorities, and transmission of the first physical uplink shared channel (PUSCH) and the transmission of the second physical uplink shared channel (PUSCH) at least partially overlap in the time domain, not transmitting the second physical uplink shared channel (PUSCH) by the terminal equipment 102; and

operation 702: transmitting transmission indication information by the physical layer to the media access control (MAC) layer, the transmission indication information being used to notify the media access control (MAC) layer that the data of the second physical uplink shared channel (PUSCH) are not transmitted.

In Embodiment 1, the moment when the physical layer of the terminal equipment 102 receives the data of the second physical uplink shared channel (PUSCH) from the media access control (MAC) layer is later than the moment when the data of the first physical uplink shared channel (PUSCH) are received, that is, a priority of the MAC layer of the second PUSCH is higher than a priority of the MAC layer of the first PUSCH.

With operation 702, the physical layer may notify the MAC layer that the data of the second physical uplink shared channel (PUSCH) are not transmitted, hence, the MAC layer may perform subsequent processing on the second PUSCH, thereby avoiding drop of the data of the second PUSCH, and improving reliability of communication services.

As shown in FIG. 7, the method may further include:

operation 703: determining an uplink grant corresponding to the second physical uplink shared channel (PUSCH) by the media access control (MAC) layer as an uplink grant of a low priority.

The MAC layer may execute operation 703 after receiving the transmission indication information transmitted by the physical layer in operation 702. With operation 703, the MAC layer may automatically initiate retransmission of the data of the second PUSCH, so as to avoid drop of data.

As shown in FIG. 7, the method may further include:

operation 704: determining an uplink grant corresponding to the first physical uplink shared channel (PUSCH) by the media access control (MAC) layer as an uplink grant of a high priority.

The MAC layer may execute operation 704 after receiving the transmission indication information transmitted by the physical layer in operation 702.

In Embodiment 1, the first physical uplink shared channel (PUSCH) is a physical uplink shared channel (PUSCH) scheduled by downlink control information (DCI), and the second physical uplink shared channel (PUSCH) is a physical uplink shared channel (PUSCH) of a configured grant (CG); or, the first physical uplink shared channel (PUSCH) a physical uplink shared channel (PUSCH) of a configured grant (CG), and the second physical uplink shared channel (PUSCH) is a physical uplink shared channel (PUSCH) of a configured grant (CG)

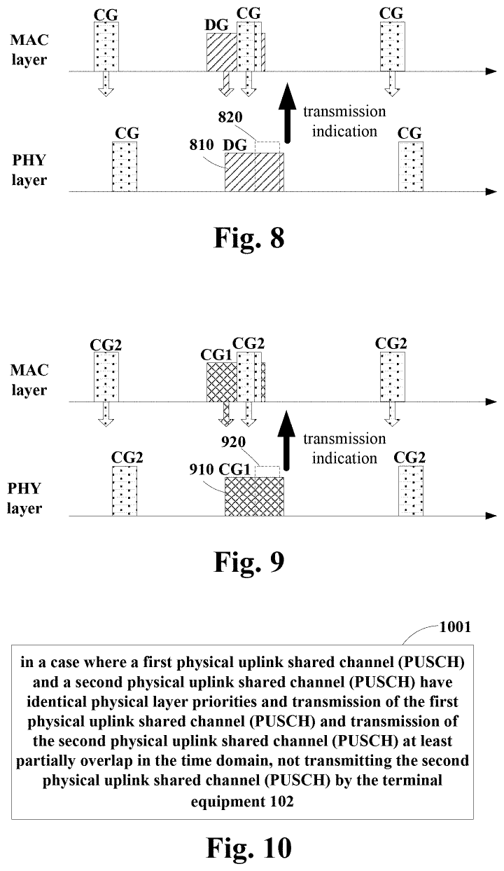

FIG. 8 is a schematic diagram of operations of the MAC layer and the physical layer of Embodiment 1. As shown in FIG. 8, the first PUSCH 810 is a PUSCH scheduled by first downlink control information (i.e. a dynamic scheduling grant (DG)), the second PUSCH 820 is a PUSCH of the configured grant (CG)), and a moment when the data of the second PUSCH 820 arrive at the physical layer is later than a moment when the data of the first PUSCH 810 arrive at the physical layer. As shown in FIG. 8, the physical layer of the terminal equipment 102 does not transmit the second PUSCH 820, and the physical layer transmits a transmission indication to the MAC layer, the transmission indication being used to notify the MAC layer that the data of the second PUSCH 820 are not transmitted. Furthermore, in a case of receiving the transmission indication by the MAC layer, it may set the uplink grant (i.e. the CG) corresponding to the second PUSCH 820 to be a grant of low priority, and set the uplink grant corresponding to the first PUSCH 810 to be a grant of high priority.

FIG. 9 is another schematic diagram of the operations of the MAC layer and the physical layer of Embodiment 1. As shown in FIG. 9, the first PUSCH 910 is a PUSCH of a configured grant (DG) 1, the second PUSCH 920 is a PUSCH of a DG 2, and a moment when the data of the second PUSCH 920 arrive at the physical layer is later than a moment when the data of the first PUSCH 910 arrive at the physical layer. As shown in FIG. 9, the physical layer of the terminal equipment 102 does not transmit the second PUSCH 920, and the physical layer transmits a transmission indication to the MAC layer, the transmission indication being used to notify the MAC layer that the data of the second PUSCH 920 are not transmitted. Furthermore, in a case of receiving the transmission indication by the MAC layer, it may set the uplink grant (i.e. CG 2) corresponding to the second PUSCH 920 to be a grant of low priority, and set the uplink grant corresponding to the first PUSCH 910 (i.e. CG 1) to be a grant of high priority.

### Embodiment 2

FIG. 10 is a schematic diagram of the method for transmitting data of Embodiment 2 of the second aspect of the embodiments of this disclosure. As shown in FIG. 10, the method includes:

operation 1001: in a case where a first physical uplink shared channel (PUSCH) and a second physical uplink shared channel (PUSCH) have identical physical layer priorities and transmission of the first physical uplink shared channel (PUSCH) and transmission of the second physical uplink shared channel (PUSCH) at least partially overlap in the time domain, not transmitting the second physical uplink shared channel (PUSCH) by the terminal equipment 102.

In Embodiment 2, operation 1001 may include: not generating the data of the second physical uplink shared channel (PUSCH) by a media access control (MAC) layer of the terminal equipment if the media access control (MAC) layer has generated the data of the first physical uplink shared channel (PUSCH). As the MAC layer does not generate the data of the second PUSCH, the terminal equipment 102 is unable to transmit the data of the second PUSCH, thus, non-uniform operations of whether to transmit the second PUSCH by the MAC layer and the physical layer will not be resulted.

Wherein, the not generating the data of the second physical uplink shared channel (PUSCH) by a media access control (MAC) layer may be implemented in two modes.

In a first mode, the MAC layer does not determine the uplink grant to which the second physical uplink shared channel (PUSCH) corresponds as an uplink grant of a high priority, and does not generate the data of the second physical uplink shared channel (PUSCH).

Wherein, if the first physical uplink shared channel (PUSCH) does not exist, wherein the uplink grant to which the first physical uplink shared channel (PUSCH) corresponds has acquired a media access control protocol data unit (MAC PDU), the MAC layer determines that the uplink grant to which the second physical uplink shared channel (PUSCH) corresponds as an uplink grant of a high priority, and generates the data of the second physical uplink shared channel (PUSCH); otherwise, the media access control (MAC) layer determines that the uplink grant to which the second physical uplink shared channel (PUSCH) corresponds is an uplink grant of low priority, and does not generate the data of the second physical uplink shared channel (PUSCH).

Furthermore, if there exists no physical uplink shared channel (PUSCH) of another configured grant (CG) of a higher priority at least partially overlapping the second physical uplink shared channel (PUSCH) in the time domain, there exists no physical uplink shared channel (PUSCH) of a higher priority or an identical priority scheduled by downlink control information (DCI) at least partially overlapping the second physical uplink shared channel (PUSCH) in the time domain, and there exists no physical uplink shared channel (PUSCH) transmitted by a scheduling request (SR) of a higher priority at least partially overlapping the second physical uplink shared channel (PUSCH), the media access control (MAC) layer determines that the uplink grant to which the second physical uplink shared channel (PUSCH) corresponds as an uplink grant of a high priority, and generate the data of the second physical uplink shared channel (PUSCH), by the media access control (MAC) layer; otherwise, the media access control (MAC) layer does not determine that the uplink grant to which the second physical uplink shared channel (PUSCH) corresponds is an uplink grant of high priority, and does not generate the data of the second physical uplink shared channel (PUSCH).

Therefore, in the first mode, as the first physical uplink shared channel (PUSCH) already exists, and the uplink grant to which the first physical uplink shared channel (PUSCH) corresponds has obtained the media access control protocol data unit (MAC PDU), the media access control (MAC) layer does not determine the uplink grant to which the second physical uplink shared channel (PUSCH) corresponds as an uplink grant of high priority, and does not generate the data of the second physical uplink shared channel (PUSCH).

In a second mode, the media access control (MAC) layer directly determines not to generate the data of the second physical uplink shared channel (PUSCH) for the uplink grant of the second PUSCH, without performing the operation of determining the priority of the uplink grant to which the second physical uplink shared channel (PUSCH) corresponds.

For example, if there exists no first physical uplink shared channel (PUSCH), wherein the uplink grant to which the first physical uplink shared channel (PUSCH) corresponds has acquired a media access control protocol data unit (MAC PDU), the media access control protocol data unit (MAC PDU) may be generated for the uplink grant to which the second physical uplink shared channel (PUSCH) corresponds; otherwise, the media access control (MAC) layer determines that the uplink grant to which the second physical uplink shared channel (PUSCH) corresponds is an uplink grant of low priority, and does not generate the data of the second physical uplink shared channel (PUSCH).

Therefore, in the second mode, as the first physical uplink shared channel (PUSCH) already exists and the uplink grant to which the first physical uplink shared channel (PUSCH) corresponds has obtained the media access control protocol data unit (MAC PDU), the media access control (MAC) layer does not generate the data of the second physical uplink shared channel (PUSCH), thereby avoiding non-uniform operations of whether to transmit the second PUSCH by the MAC layer and the physical layer.

In Embodiment 2, the first physical uplink shared channel (PUSCH) is a physical uplink shared channel (PUSCH) scheduled by downlink control information (DCI) (i.e. a dynamic scheduling grant (DG)), or a physical uplink shared channel (PUSCH) of a configured grant (CG), and the second physical uplink shared channel (PUSCH) is a physical uplink shared channel (PUSCH) of a configured grant (CG).

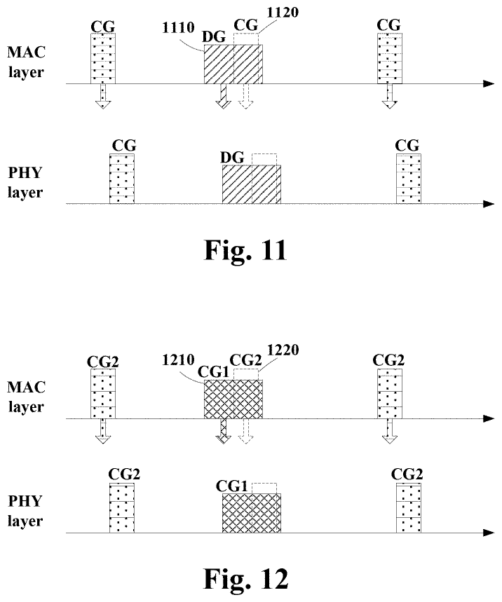

FIG. 11 is a schematic diagram of operations of the MAC layer and the physical layer of Embodiment 2. As shown in FIG. 11, a first PUSCH 1110 is a PUSCH scheduled by first downlink control information (i.e. a dynamic scheduling grant (DG)), a second PUSCH 1120 is a PUSCH of a configured grant (CG), the MAC layer has generated data of the first PUSCH 1110, and no longer generates data of the second PUSCH 1120 (denoted by dotted lines in the figure). Therefore, the MAC layer generates the data of the first PUSCH 1110 and transmits the data to the physical layer, and the physical layer transmits the data of the first PUSCH 1110; and the MAC layer does not generate the data of the second PUSCH 1120, hence, the physical layer does not transmit the data of the second PUSCH 1120.

FIG. 12 is a schematic diagram of the operations of the MAC layer and the physical layer of Embodiment 2. As shown in FIG. 12, a first PUSCH 1210 is a PUSCH of a configured grant (CG) 1, a second PUSCH 1220 is a PUSCH of a configured grant (CG) 2, the MAC layer has generated data of the first PUSCH 1210, and no longer generates data of the second PUSCH 1220 (denoted by dotted lines in the figure). Therefore, the MAC layer generates the data of the first PUSCH 1210 and transmits the data to the physical layer, and the physical layer transmits the data of the first PUSCH 1210; and the MAC layer does not generate the data of the second PUSCH 1220, hence, the physical layer does not transmit the data of the second PUSCH 1220.

### Embodiment 3

A difference between Embodiment 3 and Embodiment 2 exits in that specific mode for executing operation 1001 is different. In Embodiment 3, a first physical uplink shared channel (PUSCH) is a physical uplink shared channel (PUSCH) scheduled by downlink control information (DCI) or a physical uplink shared channel (PUSCH) of a configured grant (CG), and the second physical uplink shared channel (PUSCH) is an uplink shared channel (PUSCH) of a configured grant (CG).

In Embodiment 3, operation 1001 may include: not determining an uplink grant to which the second physical uplink shared channel (PUSCH) corresponds as an uplink grant of high priority by the media access control (MAC) layer of the terminal equipment, and not generating data of the second physical uplink shared channel (PUSCH). As the MAC layer does not determine the uplink grant to which the second PUSCH corresponds as an uplink grant of high priority and does not generate the data of the second PUSCH, the terminal equipment 102 is unable to transmit the data of the second PUSCH, thereby avoiding non-uniform operations of whether to transmit the second PUSCH by the MAC layer and the physical layer.

Wherein, if there exists no first PUSCH of the physical uplink shared channel, the media access control (MAC) layer of the terminal equipment determines the uplink grant to which the second physical uplink shared channel (PUSCH) corresponds as an uplink grant of high priority, and generates data of the second physical uplink shared channel (PUSCH).

Furthermore, the media access control (MAC) layer of the terminal equipment also determines the priority of the uplink grant to which the second physical uplink shared channel (PUSCH) corresponds in a method as below:

if there exists no physical uplink shared channel (PUSCH) of another configured grant (CG) of a higher priority at least partially overlapping the second physical uplink shared channel (PUSCH) in the time domain, there exists no physical uplink shared channel (PUSCH) of a higher priority or an identical priority scheduled by downlink control information (DCI) at least partially overlapping the second physical uplink shared channel (PUSCH) in the time domain, and there exists no physical uplink shared channel (PUSCH) transmitted by a scheduling request (SR) of a higher priority at least partially overlapping the second physical uplink shared channel (PUSCH), determining by the media access control (MAC) layer of the terminal equipment that the uplink grant to which the second physical uplink shared channel (PUSCH) corresponds as an uplink grant of a high priority; otherwise, not determining by the media access control (MAC) layer of the terminal equipment that the uplink grant to which the second physical uplink shared channel (PUSCH) corresponds as an uplink grant of a high priority

According to the above method for determining the priority of the uplink grant to which the second PUSCH corresponds, the media access control (MAC) layer has the first physical uplink shared channel (PUSCH), the priority of the first physical uplink shared channel (PUSCH) is identical to that of the second PUSCH, and the first PUSCH and the second PUSCH at least partially overlap in the time domain. Hence, the media access control (MAC) layer does not determine the uplink grant to which the second physical uplink shared channel (PUSCH) corresponds as an uplink grant of a high priority.

Furthermore, in Embodiment 3, the media access control (MAC) layer does not determine the uplink grant to which the second physical uplink shared channel (PUSCH) corresponds as an uplink grant of a high priority. In this way, the MAC lay may actively initiate retransmission of the data of the second PUSCH, thereby avoiding drop of the data of the second PUSCH.

According to Embodiment 3, when the second PUSCH and the first PUSCH are identical with respect to the physical layer priorities and at least partially overlap in the time domain, the MAC layer determines the priority of the uplink grant to which the second PUSCH corresponds according to a logical channel priority and the physical layer priority of the PUSCH. Therefore, the transmission priority of the MAC layer may be in consistence with the transmission priority of the physical layer, thereby preventing the data of the second PUSCH that are originally high-priority data from being dropped by the physical layer.

A method for determining the priorities of the uplink grants to which the first PUSCH and the second PUSCH respectively correspond by the MAC in Embodiment 3 shall be described below.

In the case where the first physical uplink shared channel (PUSCH) is the physical uplink shared channel (PUSCH) scheduled by the downlink control information (DCI) and the second physical uplink shared channel (PUSCH) is the physical uplink shared channel (PUSCH) of the configured grant (CG), the MAC layer may determine the priorities of the uplink grants to which the first PUSCH and the second PUSCH respectively correspond in the following methods:

for the CG grant to which the second PUSCH corresponds, if there exists no PUSCH scheduled by downlink control information (DCI) (i.e. a dynamic scheduling grant) with a higher physical layer priority or identical physical layer priority at least partially overlapping the PUSCH of the CG in the time domain, the MAC determines the CG grant to which the second PUSCH corresponds as being of a high priority; otherwise, the MAC does not determine it as being of a high priority;

and for the CG grant to which the first PUSCH corresponds, if there exists no other PUSCH of the CG with a higher priority at least partially overlapping the first PUSCH in the time domain, wherein a physical layer priority of the PUSCH of the CG with a higher priority is higher than the physical layer priority of the first PUSCH, the MAC determines the uplink grant to which the first PUSCH corresponds as being of a high priority; otherwise, the MAC does not determine it as being of a high priority.

For example, for the CG grant to which the second PUSCH corresponds, if there exists no other PUSCH of the CG of a higher priority at least partially overlapping the second PUSCH in the time domain, there exists no PUSCH of a higher priority or identical priority scheduled by downlink control information (DCI) (i.e. a dynamic scheduling grant) at least partially overlapping the second PUSCH in the time domain, there exists no PUSCH of a higher physical layer priority or identical physical layer priority scheduled by downlink control information (DCI) (i.e. a dynamic scheduling grant) at least partially overlapping the second PUSCH in the time domain, and there exists no PUCCH resource of SR transmission of a higher priority at least partially overlapping the second PUSCH in the time domain, the MAC determines that the CG grant to which the second PUSCH corresponds is an uplink grant of a high priority, and determines that uplink grants corresponding to other PUSCHs at least partially overlapping the second PUSCH in the time domain are uplink grants of low priorities.

For another example, for the uplink grant to which the first PUSCH corresponds, if there exists no other PUSCH of the CG of a higher priority at least partially overlapping the first PUSCH in the time domain, wherein a physical layer priority of the PUSCH of the CG of a higher priority is higher than the physical layer priority of the uplink grant of the first PUSCH, and there exists no PUCCH resource of SR transmission of a higher priority at least partially overlapping the first PUSCH in the time domain, the MAC determines that the uplink grant to which the first PUSCH corresponds is a grant of a high priority, and determines that uplink grants corresponding to other PUSCHs at least partially overlapping the first PUSCH in the time domain are uplink grants of low priorities.

In the case where the first physical uplink shared channel (PUSCH) is the physical uplink shared channel (PUSCH) of the configured grant (CG) and the second physical uplink shared channel (PUSCH) is the physical uplink shared channel (PUSCH) of the configured grant (CG), the MAC layer may determine the priorities of the uplink grants to which the first PUSCH and the second PUSCH respectively correspond in a method as below:

For the CG grant to which the first PUSCH or the second PUSCH corresponds, if there exists no other PUSCH of the CG of a higher physical layer priority or identical physical layer priority at least partially overlapping the PUSCH of the CG in the time domain, the MAC determines the CG grant to which the first PUSCH or the second PUSCH corresponds as being of a high priority, otherwise, the MAC does not determine it as being of a high priority.

For example, the CG grant to which the first PUSCH or the second PUSCH corresponds, if there exists no other PUSCH of the CG of a higher priority or identical priority at least partially overlapping the PUSCH of the CG (i.e. the first PUSCH or the second PUSCH) in the time domain, there exists no PUSCH of a CG of a higher physical layer priority or identical physical layer priority at least partially overlapping the PUSCH of the CG in the time domain, there exists no PUSCH of a higher priority or identical priority scheduled by downlink control information (DCI) (i.e. a dynamic scheduling grant) at least partially overlapping the PUSCH of the CG in the time domain, and there exists no PUCCH resource of SR transmission of a higher priority at least partially overlapping the PUSCH of the CG in the time domain, the MAC determines that the CG to which the first PUSCH or the second PUSCH corresponds is an uplink grant of a high priority, and determines that uplink grants corresponding to other PUSCHs at least partially overlapping the first PUSCH or the second PUSCH in the time domain are uplink grants of low priorities.

In Embodiment 4, in the case where the MAC layer determines that the uplink grant to which the first PUSCH corresponds is an uplink grant of a high priority, the MAC layer may further generate the data of the first PUSCH and transmit the data to the physical layer, and the physical layer transmits out the data of the first PUSCH.

Embodiment 1, Embodiment 2 and Embodiment 3 of the method for transmitting data of the second aspect of the embodiments of this disclosure are described above.

In the second aspect of the embodiments of this disclosure, the terminal equipment 102 may transmit data in any one of the methods described in Embodiment 1, Embodiment 2 and Embodiment 3.

### Third Aspect of the Embodiments

The third aspect of the embodiments of this disclosure relates to a method for transmitting data, applicable to a terminal equipment, such as the terminal equipment 102.

In the third aspect of the embodiments of this disclosure, the terminal equipment 102 may perform selection, so as to use the method for transmitting data described in the first aspect or the second aspect of the embodiments.

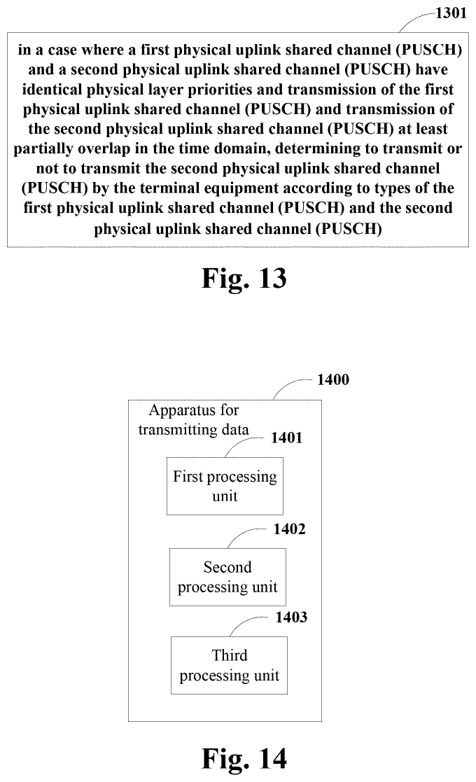

FIG. 13 is a schematic diagram of the method for transmitting data of the third aspect of the embodiments of this disclosure. As shown in FIG. 13, the method includes:

operation 1301: in a case where a first physical uplink shared channel (PUSCH) and a second physical uplink shared channel (PUSCH) have identical physical layer priorities and transmission of the first physical uplink shared channel (PUSCH) and transmission of the second physical uplink shared channel (PUSCH) at least partially overlap in the time domain, determining to transmit or not to transmit the second physical uplink shared channel (PUSCH) by the terminal equipment according to types of the first physical uplink shared channel (PUSCH) and the second physical uplink shared channel (PUSCH).

In at least one embodiment, in a case where the first physical uplink shared channel (PUSCH) is a physical uplink shared channel (PUSCH) of a configured grant (CG) and the second physical uplink shared channel (PUSCH) is a physical uplink shared channel (PUSCH) of a configured grant (CG), the terminal equipment 102 determines to transmit the second physical uplink shared channel (PUSCH), that is, the first aspect of the embodiments of this disclosure; and furthermore, in a case where the first physical uplink shared channel (PUSCH) is a physical uplink shared channel (PUSCH) scheduled by downlink control information (DCI) and the second physical uplink shared channel (PUSCH) is a physical uplink shared channel (PUSCH) of a configured grant (CG), the physical layer determines not to transmit the second physical uplink shared channel (PUSCH), that is, the second aspect of the embodiments of this disclosure.

In at least another embodiment, in a case where the first physical uplink shared channel (PUSCH) is a physical uplink shared channel (PUSCH) of a configured grant (CG) and the second physical uplink shared channel (PUSCH) is a physical uplink shared channel (PUSCH) of a configured grant (CG), the terminal equipment 102 determines not to transmit the second physical uplink shared channel (PUSCH), that is, the second aspect of the embodiments of this disclosure; and furthermore, in a case where the first physical uplink shared channel (PUSCH) is a physical uplink shared channel (PUSCH) scheduled by downlink control information (DCI) and the second physical uplink shared channel (PUSCH) is a physical uplink shared channel (PUSCH) of a configured grant (CG), the physical layer determines to transmit the second physical uplink shared channel (PUSCH), that is, the first aspect of the embodiments of this disclosure.

In addition, in the third aspect of the embodiments of this disclosure, the terminal equipment 102 may also perform selection for Embodiment 1, Embodiment 2 and Embodiment 3 in the second aspect of the embodiments of this disclosure, so as to transmit data.

For example, in a case where the first physical uplink shared channel (PUSCH) is a physical uplink shared channel (PUSCH) of a configured grant (CG) and the second physical uplink shared channel (PUSCH) is a physical uplink shared channel (PUSCH) of a configured grant (CG), the terminal equipment 102 uses the method of Embodiment 2 or Embodiment 3; and furthermore, in a case where the first physical uplink shared channel (PUSCH) is a physical uplink shared channel (PUSCH) scheduled by downlink control information (DCI) and the second physical uplink shared channel (PUSCH) is a physical uplink shared channel (PUSCH) of a configured grant (CG), the terminal equipment 102 uses the method of Embodiment 1.

For another example, in a case where the first physical uplink shared channel (PUSCH) is a physical uplink shared channel (PUSCH) of a configured grant (CG) and the second physical uplink shared channel (PUSCH) is a physical uplink shared channel (PUSCH) of a configured grant (CG), the terminal equipment 102 uses the method of Embodiment 2; and furthermore, in a case where the first physical uplink shared channel (PUSCH) is a physical uplink shared channel (PUSCH) scheduled by downlink control information (DCI) and the second physical uplink shared channel (PUSCH) is a physical uplink shared channel (PUSCH) of a configured grant (CG), the terminal equipment 102 uses the method of Embodiment 3.

### Fourth Aspect of the Embodiments

The fourth aspect of the embodiments of this disclosure provides an apparatus for transmitting data, applicable to a terminal equipment, such as the terminal equipment 102.

FIG. 14 is a schematic diagram of the apparatus for transmitting data of the fourth aspect of the embodiments of this disclosure. As shown in FIG. 14, the apparatus 1400 for transmitting data may include a first processing unit 1401, a second processing unit 1402 or a third processing unit 1403.

The first processing unit 1401 may control the terminal equipment, so that the terminal equipment carries out the method for transmitting data described in the first aspect of the embodiments of this disclosure. Reference may be made to the description of the method for transmitting data in the first aspect of the embodiments of this disclosure for description of the method for transmitting data carried out by the first processing unit 1401.

The second processing unit 1402 may control the terminal equipment, so that the terminal equipment carries out the method for transmitting data described in the second aspect of the embodiments of this disclosure. Reference may be made to the description of the method for transmitting data in the second aspect of the embodiments of this disclosure for description of the method for transmitting data carried out by the second processing unit 1402.

The third processing unit 1403 may control the terminal equipment, so that the terminal equipment carries out the method for transmitting data described in the third aspect of the embodiments of this disclosure. Reference may be made to the description of the method for transmitting data in the third aspect of the embodiments of this disclosure for description of the method for transmitting data carried out by the third processing unit 1403.

### Fifth Aspect of the Embodiments

The fifth aspect of the embodiments of this disclosure provides a terminal equipment, including the apparatus 1400 for transmitting data as described in the third aspect of the embodiments.

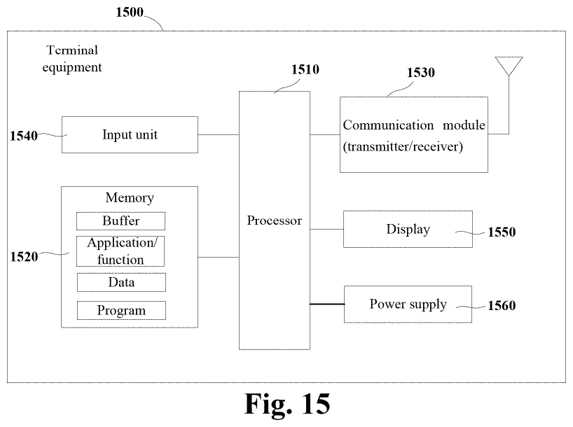

FIG. 15 is a block diagram of a systematic structure of the terminal equipment of the fifth aspect of the embodiments of this disclosure. As shown in FIG. 15, the terminal equipment 1500 may include a processor 1510 and a memory 1520, the memory 1520 being coupled to the processor 1510. It should be noted that this figure is illustrative only, and other types of structures may also be used, so as to supplement or replace this structure and achieve a telecommunications function or other functions.

In some embodiments, the functions of the apparatus 1400 for transmitting data may be integrated into the processor 1510. Wherein, the processor 1510 may be configured to carry out the method as described in the first or the second or the third aspect of the embodiments.

In another implementation, the apparatus 1400 for transmitting data and the processor 1510 may be configured separately; for example, the apparatus 1400 for transmitting data may be configured as a chip connected to the processor 1510, and the functions of the apparatus 1400 for transmitting data are executed under control of the processor 1510.

As shown in FIG. 15, the terminal equipment 1500 may further include a communication module 1530, an input unit 1540, a display 1550, and a power supply 1560. It should be noted that the terminal equipment 1500 does not necessarily include all the parts shown in FIG. 15, and the above components are not necessary. Furthermore, the terminal equipment 1500 may include parts not shown in FIG. 15, and the related art may be referred to.

As shown in FIG. 15, the processor 1510 is sometimes referred to as a controller or an operational control, which may include a microprocessor or other processor devices and/or logic devices. The processor 1510 receives input and controls operations of components of the terminal equipment 1500.

Wherein, the memory 1520 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 1510 may execute programs stored in the memory 1520, so as to realize information storage or processing, etc. Functions of other parts are similar to those of the related art, which shall not be described herein any further. The parts of the terminal equipment 1500 may be realized by specific hardware, firmware, software, or any combination thereof, without departing from the scope of this disclosure.

### Sixth Aspect of the Embodiments

The sixth aspect of the embodiments of this disclosure provides a communication system, including a network device and the terminal equipment described in the fifth aspect of the embodiments.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. A method for transmitting data, applicable to a terminal equipment, the method including:

transmitting a second physical uplink shared channel (PUSCH) by the terminal equipment in a case where a first physical uplink shared channel (PUSCH) and the second physical uplink shared channel (PUSCH) have identical physical layer priorities and transmission of the first physical uplink shared channel (PUSCH) and transmission of the second physical uplink shared channel (PUSCH) at least partially overlap in the time domain.

2. The method according to supplement 1, wherein,

a moment when a physical layer of the terminal equipment receives data of the second physical uplink shared channel (PUSCH) from a media access control (MAC) layer is later than a moment when data of the first physical uplink shared channel (PUSCH) are received.

3. The method according to supplement 1 or 2, wherein, the first physical uplink shared channel (PUSCH) is a physical uplink shared channel (PUSCH) scheduled by first downlink control information (DCI), and the second physical uplink shared channel (PUSCH) is a physical uplink shared channel (PUSCH) of a configured grant (CG).

4. The method according to supplement 1 or 2, wherein,

the first physical uplink shared channel (PUSCH) is a physical uplink shared channel (PUSCH) of a configured grant (CG), and the second physical uplink shared channel (PUSCH) is a physical uplink shared channel (PUSCH) of a configured grant (CG).

5. A method for transmitting data, applicable to a terminal equipment, the method including:

in a case where a first physical uplink shared channel (PUSCH) and a second physical uplink shared channel (PUSCH) have identical physical layer priorities,

and transmission of the first physical uplink shared channel (PUSCH) and the transmission of the second physical uplink shared channel (PUSCH) at least partially overlap in the time domain, not transmitting the second physical Uplink shared channel (PUSCH) by the terminal equipment.

6. The method for transmitting data according to supplement 5, wherein,

a moment when a physical layer of the terminal equipment receives data of the second physical uplink shared channel (PUSCH) from a media access control (MAC) layer is later than a moment when data of the first physical uplink shared channel (PUSCH) are received,

and the method further includes:

transmitting transmission indication information by the physical layer to the media access control (MAC) layer, the transmission indication information being used to notify the media access control (MAC) layer that the data of the second physical uplink shared channel (PUSCH) are not transmitted.

7. The method for transmitting data according to supplement 6, wherein the method further includes:

determining the uplink grant to which the second physical uplink shared channel (PUSCH) corresponds as an uplink grant of a low priority by the media access control (MAC) layer.

8. The method for transmitting data according to supplement 6, wherein the method further includes:

determining the uplink grant to which the first physical uplink shared channel (PUSCH) corresponds as an uplink grant of a high priority by the media access control (MAC) layer.

9. The method for transmitting data according to any one of supplements 6-8, wherein,

the first physical uplink shared channel (PUSCH) is a physical uplink shared channel (PUSCH) scheduled by downlink control information (DCI),

and the second physical uplink shared channel (PUSCH) is a physical uplink shared channel (PUSCH) of a configured grant (CG).

10. The method for transmitting data according to any one of supplements 6-8, wherein,

the first physical uplink shared channel (PUSCH) is a physical uplink shared channel (PUSCH) of a configured grant (CG),

and the second physical uplink shared channel (PUSCH) is a physical uplink shared channel (PUSCH) of a configured grant (CG).

11. The method for transmitting data according to supplement 5, wherein the not transmitting the second physical uplink shared channel (PUSCH) by the terminal equipment includes:

not generating the data of the second physical uplink shared channel (PUSCH) by a media access control (MAC) layer of the terminal equipment if the media access control (MAC) layer has generated the data of the first physical uplink shared channel (PUSCH).

12. The method for transmitting data according to supplement 11, wherein the not generating the data of the second physical uplink shared channel (PUSCH) by a media access control (MAC) layer comprises:

not determining the uplink grant to which the second physical uplink shared channel (PUSCH) corresponds as an uplink grant of a high priority, and not generating the data of the second physical uplink shared channel (PUSCH), by the media access control (MAC) layer.

13. The method for transmitting data according to supplement 12, wherein,

the first physical uplink shared channel (PUSCH) is a physical uplink shared channel (PUSCH) scheduled by downlink control information (DCI) or a physical uplink shared channel (PUSCH) of a configured grant (CG),

and the second physical uplink shared channel (PUSCH) is a physical uplink shared channel (PUSCH) of a configured grant (CG).

14. The method for transmitting data according to supplement 13, wherein the method further includes:

if the first physical uplink shared channel (PUSCH) does not exist, wherein the uplink grant to which the first physical uplink shared channel (PUSCH) corresponds has acquired a media access control protocol data unit (MAC PDU),

determining that the uplink grant to which the second physical uplink shared channel (PUSCH) corresponds as an uplink grant of a high priority, and generating the data of the second physical uplink shared channel (PUSCH), by the media access control (MAC) layer.

15. The method for transmitting data according to supplement 14, wherein the determining that the uplink grant to which the second physical uplink shared channel (PUSCH) corresponds as an uplink grant of a high priority by the media access control (MAC) layer includes:

if there exists no physical uplink shared channel (PUSCH) of another configured grant (CG) of a higher priority at least partially overlapping the second physical uplink shared channel (PUSCH) in the time domain, there exists no physical uplink shared channel (PUSCH) of a higher priority or an identical priority scheduled by downlink control information (DCI) at least partially overlapping the second physical uplink shared channel (PUSCH) in the time domain, and there exists no physical uplink shared channel (PUSCH) transmitted by a scheduling request (SR) of a higher priority at least partially overlapping the second physical uplink shared channel (PUSCH),

determining that the uplink grant to which the second physical uplink shared channel (PUSCH) corresponds as an uplink grant of a high priority, and generating the data of the second physical uplink shared channel (PUSCH), by the media access control (MAC) layer.

16. The method for transmitting data according to supplement 12, wherein the method further includes:

if the first physical uplink shared channel (PUSCH) does not exist and the uplink grant to which the first physical uplink shared channel (PUSCH) corresponds has acquired a media access control protocol data unit (MAC PDU),

generating a media access control protocol data unit (MAC PDU) for the uplink grant to which the second physical uplink shared channel (PUSCH) data corresponds.

17. The method for transmitting data according to supplement 5, wherein the not transmitting the second physical uplink shared channel (PUSCH) by the terminal equipment includes:

not determining the uplink grant to which the second physical uplink shared channel (PUSCH) corresponds as an uplink grant of a high priority, and not generating the data of the second physical uplink shared channel (PUSCH), by the media access control (MAC) layer of the terminal equipment.

18. The method according to supplement 17, wherein the method further includes:

if the first physical uplink shared channel (PUSCH) does not exist, determining the uplink grant to which the second physical uplink shared channel (PUSCH) corresponds as an uplink grant of a high priority, and generating the data of the second physical uplink shared channel (PUSCH), by the media access control (MAC) layer of the terminal equipment.

19. The method according to supplement 18, wherein,

the first physical uplink shared channel (PUSCH) is a physical uplink shared channel (PUSCH) scheduled by downlink control information (DCI) or a physical uplink shared channel (PUSCH) of a configured grant (CG),

and the second physical uplink shared channel (PUSCH) is a physical uplink shared channel (PUSCH) of a configured grant (CG).

20. The method according to supplement 19, wherein the method further includes:

if there exists no physical uplink shared channel (PUSCH) of another configured grant (CG) of a higher priority at least partially overlapping the second physical uplink shared channel (PUSCH) in the time domain, there exists no physical uplink shared channel (PUSCH) of a higher priority or an identical priority scheduled by downlink control information (DCI) at least partially overlapping the second physical uplink shared channel (PUSCH) in the time domain, and there exists no physical uplink shared channel (PUSCH) transmitted by a scheduling request (SR) of a higher priority at least partially overlapping the second physical uplink shared channel (PUSCH),

determining that the uplink grant to which the second physical uplink shared channel (PUSCH) corresponds as an uplink grant of a high priority by the media access control (MAC) layer of the terminal equipment.

21. The method according to supplement 5, wherein the method further includes: transmitting the first physical uplink shared channel (PUSCH) by the terminal equipment.

22. The method according to claim 17, wherein the transmitting the first physical uplink shared channel (PUSCH) by the terminal equipment includes:

determining the uplink grant to which the first physical uplink shared channel (PUSCH) corresponds as an uplink grant of a high priority, and generating the data of the first physical uplink shared channel (PUSCH), by the media access control (MAC) layer.

23. The method according to supplement 22, wherein,

the first physical uplink shared channel (PUSCH) is a physical uplink shared channel (PUSCH) scheduled by downlink control information (DCI), and the second physical uplink shared channel (PUSCH) is a physical uplink shared channel (PUSCH) of a configured grant (CG).

24. The method according to supplement 23, wherein the determining the uplink grant to which the first physical uplink shared channel (PUSCH) corresponds as an uplink grant of a high priority by the media access control (MAC) layer includes:

if there exists no other physical uplink shared channel (PUSCH) of a CG of a higher priority at least partially overlapping the first physical uplink shared channel (PUSCH) in the time domain, wherein a physical layer priority of the configured grant (CG) is higher than the physical layer priority of first physical uplink shared channel (PUSCH), and there exists no physical uplink shared channel of SR transmission of a higher priority at least partially overlapping the first PUSCH in the time domain,

determining by the media access control (MAC) layer that the uplink grant to which the first PUSCH corresponds is an uplink grant of a high priority.

25. A method for transmitting data, applicable to a terminal equipment, the method including:

in a case where a first physical uplink shared channel (PUSCH) and a second physical uplink shared channel (PUSCH) have identical physical layer priorities and transmission of the first physical uplink shared channel (PUSCH) and transmission of the second physical uplink shared channel (PUSCH) at least partially overlap in the time domain,

determining to transmit or not to transmit the second physical uplink shared channel (PUSCH) by the terminal equipment according to types of the first physical uplink shared channel (PUSCH) and the second physical uplink shared channel (PUSCH).

26. The method according to supplement 25, wherein the determining to transmit or not to transmit the second physical uplink shared channel (PUSCH) by the terminal equipment according to types of the first physical uplink shared channel (PUSCH) and the second physical uplink shared channel (PUSCH) includes:

in a case where the first physical uplink shared channel (PUSCH) is a physical uplink shared channel (PUSCH) of a configured grant (CG) and the second physical uplink shared channel (PUSCH) is a physical uplink shared channel of a configured grant (CG), determining by the terminal equipment to transmit the second physical uplink shared channel (PUSCH); and

in a case where the first physical uplink shared channel (PUSCH) is a physical uplink shared channel (PUSCH) scheduled by downlink control information and the second physical uplink shared channel (PUSCH) is a physical uplink shared channel of a configured grant (CG), determining by the terminal equipment not to transmit the second physical uplink shared channel (PUSCH).

27. The method according to supplement 25, wherein the determining to transmit or not to transmit the second physical uplink shared channel (PUSCH) by the terminal equipment according to types of the first physical uplink shared channel (PUSCH) and the second physical uplink shared channel (PUSCH) includes:

in a case where the first physical uplink shared channel (PUSCH) is a physical uplink shared channel (PUSCH) of a configured grant (CG) and the second physical uplink shared channel (PUSCH) is a physical uplink shared channel of a configured grant (CG), determining by the terminal equipment not to transmit the second physical uplink shared channel (PUSCH); and

in a case where the first physical uplink shared channel (PUSCH) is a physical uplink shared channel (PUSCH) scheduled by downlink control information and the second physical uplink shared channel (PUSCH) is a physical uplink shared channel of a configured grant (CG), determining by the terminal equipment to transmit the second physical uplink shared channel (PUSCH).

What is claimed is:

1. A terminal equipment comprising:
a transmitter configured to transmit a first physical uplink shared channel (PUSCH) or a second physical uplink shared channel (PUSCH), and
a processor configured to cancel, when the first PUSCH and the second PUSCH have identical physical layer priority and the first PUSCH and the second PUSCH are partially or fully overlapping in the time domain, the transmission of the second PUSCH, wherein
when the transmission of the second PUSCH is cancelled by a physical layer of the terminal equipment, a media access control (MAC) layer of the terminal equipment not obtaining a PDU of the second PUSCH.

2. The terminal equipment according to claim 1, wherein,
a moment when the physical layer of the terminal equipment receives data of the second PUSCH from MAC layer is later than a moment when data of the first PUSCH are received.

3. The terminal equipment according to claim 1, wherein,
the first PUSCH is a physical uplink shared channel (PUSCH) scheduled by a first downlink control information (DCI),
and the second PUSCH is a physical uplink shared channel (PUSCH) of a configuration grant (CG).

4. The terminal equipment according to claim 1, wherein,
the first PUSCH is a physical uplink shared channel (PUSCH) of a configuration grant (CG),
and the second physical uplink shared channel (PUSCH) is a physical uplink shared channel (PUSCH) of a configuration grant (CG).

5. The terminal equipment according to claim 1, wherein
The processor is further configured to
determine, when the first PUSCH and the second PUSCH have identical physical layer priority and the first PUSCH and the second PUSCH are partially or fully overlapping in the time domain, the transmission of the second PUSCH, an uplink grant to which the second PUSCH corresponds as an uplink grant of a not high priority, and not generate the PDU of the second PUSCH, by the MAC layer.

6. The terminal equipment according to claim 5, wherein,
the first physical uplink shared channel (PUSCH) is a physical uplink shared channel (PUSCH) scheduled by downlink control information (DCI) or a physical uplink shared channel (PUSCH) of a configuration grant (CG),
and the second physical uplink shared channel (PUSCH) is a physical uplink shared channel (PUSCH) of a configuration grant (CG).

7. The terminal equipment according to claim 1, wherein,
the processor is further configured to perform, when the first PUSCH and the second PUSCH have identical physical layer priority and the first PUSCH and the second PUSCH are partially or fully overlapping in the time domain, to controlling for not dealing with the uplink grant with which the second physical uplink shared channel (PUSCH) associates, or not considering the uplink grant with which the second physical uplink shared channel (PUSCH) associates as a prioritized uplink grant by the media access control (MAC) layer, so as not to obtain the PDU of the second PUSCH.

8. The terminal equipment according to claim 1, wherein,
the processor is further configured to determine, when the first PUSCH can be transmitted by the physical layer of the terminal equipment, whether to obtain a PDU for the first PUSCH, by the media access control (MAC) layer.

9. The terminal equipment according to claim 8, wherein
the processor is further configured to obtain, when an uplink grant with which the first PUSCH associates is considered as a prioritized uplink grant, a PDU for the first PUSCH, by the MAC layer of the terminal equipment.

10. The terminal equipment according to claim 9, wherein,
the first PUSCH is a physical uplink shared channel (PUSCH) scheduled by downlink control information (DCI) or a physical uplink shared channel (PUSCH) of a configuration grant (CG),
and the second PUSCH is a physical uplink shared channel (PUSCH) of a configuration grant (CG).

11. The apparatus according to claim 10, wherein
the processor is further configured to:
when there exists no physical uplink shared channel (PUSCH) of another configuration grant (CG) of a higher priority at least partially overlapping the second PUSCH in the time domain, there exists no physical uplink shared channel (PUSCH) of a higher priority or an identical priority scheduled by downlink control information (DCI) at least partially overlapping the second physical uplink shared channel (PUSCH) in the time domain, and there exists no physical uplink shared channel (PUSCH) transmitted by a scheduling request (SR) of a higher priority at least partially overlapping the second physical uplink shared channel (PUSCH), determine that an uplink grant to which the second PUSCH corresponds as an uplink grant of a high priority.

12. The apparatus according to claim 1, wherein
the processor is further configured to:
determine an uplink grant to which the first PUSCH corresponds as an uplink grant of a high priority, and
generate the data of the first PUSCH, by the media access control (MAC) layer.

13. Abase station comprising:
a processor; and
a receiver coupled to the processor and configured to receive, from a terminal, a first physical uplink shared channel (PUSCH) or a second physical uplink shared channel (PUSCH), wherein
the transmission of the second PUSCH is cancelled by the terminal when the first PUSCH and the second PUSCH have identical physical layer priority and the first PUSCH and the second PUSCH are partially or fully overlapping in the time domain, the first PUSCH and the transmission of the second PUSCH, and
when the transmission of the second PUSCH transmission is cancelled by a physical layer of the terminal equipment, a media access control (MAC) layer of the terminal equipment not obtaining a PDU of the second PUSCH.

14. A communication system comprising:
a terminal configured to transmit first physical uplink shared channel (PUSCH) or a second physical uplink shared channel (PUSCH); and
a base station configured to receive the first PUSCH or the second PUSCH from the terminal, wherein
the terminal cancels the transmission of the second PUSCH when the first PUSCH and the second PUSCH have identical physical layer priority and the first PUSCH and the second PUSCH are partially or fully overlapping in the time domain, the first PUSCH and the transmission of the second PUSCH, and
when the transmission of the second PUSCH transmission is cancelled by a physical layer of the terminal equipment, a media access control (MAC) layer of the terminal equipment not obtaining a PDU of the second PUSCH.
